(19) United States
(12) Patent Application Publication
(10) Pub. No.: US 2026/0184101 A1
(43) Pub. Date: Jul. 2, 2026

(54) SMART PEN

(71) Applicant: THE CODDER CO., LTD., Paju-si, Gyeonggi-do (KR)

(72) Inventors: Haeng Woon PARK, Goyang-si, Gyeonggi-do (KR); Jeong Joon LEE, Incheon (KR); Kyoung Koo KANG, Seoul (KR)

(73) Assignee: THE CODDER CO., LTD., Paju-si, Gyeonggi-do (KR)

(21) Appl. No.: 18/859,158

(22) PCT Filed: Jul. 5, 2024
(86) PCT No.: PCT/KR2024/009528

§ 371 Date: Oct. 22, 2024

(30) Foreign Application Priority Data
Sep. 22, 2023 (KR) 10-2023-0127264
Jun. 27, 2024 (KR) 10-2024-0084121

(51) Int. Cl. B43K 7/10; B43K 29/08; G06V 10/44; G06V 10/762; G06V 30/41

(52) U.S. Cl. CPC B43K 7/10; B43K 29/08; G06V 10/457; G06V 10/762; G06V 30/41

(57) ABSTRACT

A smart pen according to the present invention includes an ink accommodating unit in which inks having different colors are accommodated, a scanning unit configured to extract position coordinates through a first point cluster pattern inserted into a printed matter in advance when a user writes a handwritten content on the printed matter, a pen point unit configured to print the handwritten content according to the user's manipulation through the ink discharged from the ink accommodating unit, and a control unit configured to receive the position coordinates from the scanning unit in a manipulating process of the user and control specific ink among the inks in the ink accommodating unit to be discharged according to the position coordinates.

### TECHNICAL FIELD

The present invention relates to a smart pen, and more specifically, to a smart pen that is capable of discharging ink according to a mode set by a user using position coordinates through a point cluster pattern inserted into a printed matter in advance.

### BACKGROUND ART

As the use of digital devices has become widespread in modern society, many people record and store information using computers, tablets, smartphones, etc. However, many people still prefer analog handwriting.

It is known that manual writing on paper is natural and intuitive and helps to enhance creativity and thinking ability. The smart pen was developed to provide the advantages of digital technology together while maintaining the advantages of analog handwriting.

Conventional digital input devices have limitations in accurately digitizing handwriting data. The smart pen may recognize a point cluster pattern inserted into a printed matter in advance and accurately track a user's handwriting position, thereby digitizing handwriting data more accurately. Therefore, the user may synchronize the content written on paper with a digital device in real time.

The smart pen may be used in various fields such as education, business, and creative activities. For example, when the smart pen is used in an education field, students' handwriting may be shared and stored in real time, thereby increasing learning efficiency.

In a business environment, notes taken during meetings or brainstorming sessions may be easily digitized and shared with team members. In addition, artists or designers may record and edit their creative processes in digital form using smart pens.

The emergence of smart pens has been largely influenced by advances in sensor technology, wireless communication technology, and data processing technology. In particular, the advancement of technologies that can recognize and interpret point cluster patterns inserted into a printed matter is one of the key elements of smart pens. These technologies have enabled smart pens to provide users with a more precise and intuitive writing experience.

### DISCLOSURE

### Technical Problem

The present invention is directed to providing a smart pen, which extracts position coordinates through a first point cluster pattern inserted into a printed matter in advance, recognizes a handwritten content according to the position coordinates, and then prints a second point cluster pattern according to the handwritten content to be used for authentication of the printed matter.

In addition, the present invention is directed to providing a smart pen, which discharges ink corresponding to a point cluster pattern together with ink corresponding to a handwritten content when the handwritten content is written on a printed matter so that the point cluster pattern may be inserted into the periphery of the handwritten content of the printed matter.

In addition, the present invention is directed to providing a smart pen, which extracts position coordinates through a first point cluster pattern inserted into a printed matter in advance and discharges ink through an inkjet nozzle as the position coordinates change to enable printing.

In addition, the present invention is directed to providing a smart pen, which receives an electronic document corresponding to a code value from a printed matter information providing server according to a mode selected by a user, then converts a content of the electronic document into audio data, and outputs audio for the content or provides an artificial intelligence (AI) service for the collected audio data.

In addition, the present invention is directed to providing a smart pen, which extracts a code value using a point cluster pattern inserted into a printed matter, then receives an electronic document corresponding to the code value, and provides audio for the electronic document.

In addition, the present invention is directed to providing a smart pen, which performs voice recognition so that a summary of sound collection content may be generated and provided.

In addition, the present invention is directed to providing a smart pen, which performs voice recognition so that a translation of sound collection content may be provided in real time.

### Technical Solution

A smart pen for achieving the above objects includes an ink accommodating unit in which inks having different colors are accommodated, a scanning unit configured to extract position coordinates through a first point cluster pattern inserted into a printed matter in advance when a user writes a handwritten content on the printed matter, a pen point unit configured to print the handwritten content according to the user's manipulation through the ink discharged from the ink accommodating unit, and a control unit configured to receive the position coordinates from the scanning unit in a manipulating process of the user and control specific ink among the inks in the ink accommodating unit to be discharged according to the position coordinates.

In one embodiment, the scanning unit may scan the printed matter to generate a photographed image, analyze the photographed image to extract a reference pattern on which a boundary dot is formed between a plurality of vertical dotted lines with different lengths, analyze patterns of the plurality of vertical dotted lines that constitute the reference pattern, and correct a recognition direction to a forward direction to extract position coordinates indicated by the first point cluster pattern.

In one embodiment, the scanning unit may scan the printed matter to generate and analyze the photographed image, detect a boundary dot positioned in the middle, calculate distances between the boundary dot positioned in the middle and other boundary dots, and detect another boundary dot at a shortest distance as a region setting dot.

In one embodiment, the scanning unit may detect a vertical dotted line extending upward or downward from the another boundary dot at the shortest distance and detect a boundary dot close to an end of the vertical dotted line extending upward or downward as a region setting dot.

In one embodiment, the scanning unit may determine a top and bottom of a specific region using patterns of lengths of at least three vertical dotted lines that constitute the region setting dot, correct a corresponding region according to a result of the determination, and then extract position coordinates of each first point cluster pattern of the corresponding region.

In one embodiment, the control unit may control the specific ink among the inks in the ink accommodating unit to be discharged so that a second point cluster pattern is output according to the position coordinates.

In one embodiment, the second point cluster pattern may be used to check whether the authenticity of the printed matter is verified by extracting a code value after scanning the printed matter with a user terminal when the printed matter is authenticated and then comparing the code value with a pre-stored code value.

In one embodiment, the first point cluster pattern may include a reference pattern composed of a plurality of reference dots that indicate position coordinates and a reference pattern in which vertical dotted lines with different lengths that indicate directions are formed to be spaced a specific distance from each other in a horizontal direction and a boundary dot is formed between the vertical dotted lines with different lengths.

In one embodiment, the smart pen may further include an audio collecting unit configured to collect external audio data, and an audio output unit configured to output audio data.

In one embodiment, the control unit may receive an electronic document corresponding to a position coordinate combination that combines the position coordinates received from the scanning unit from a printed matter information providing server, convert a content of the electronic document into the audio data, and output the audio data through the audio output unit or provides an artificial intelligence (AI) service for the audio data collected through the audio collecting unit.

In one embodiment, the control unit may transmit a code value extracted by the scanning unit to the printed matter information providing server when a mode selected by the user is a document content audio output mode and when receiving an electronic document corresponding to the code value from the printed matter information providing server through a communication unit, convert text data of the electronic document into audio data and control the audio data to be provided through the audio output unit.

In one embodiment, when the mode selected by the user is a translation mode, the control unit may collect audio data through the audio collecting unit, convert the audio data into text data, and then translate the text data with a target language to provide the translated text data through the audio output unit.

In one embodiment, when the mode selected by the user is a summary mode, the control unit may collect audio data through the audio collecting unit and then generate summary data of collected content to provide the summary data to a user terminal.

In one embodiment, after a printing mode is set and the user manipulates the smart pen, the control unit may receive the position coordinates from the scanning unit in a manipulating process of the user and control the specific ink among the inks in the ink accommodating unit to be discharged as the position coordinates change.

In one embodiment, the printing mode may include at least one of a user setting color printing mode, a texture printing mode, and a handwriting mode.

In one embodiment, the printed matter may be written as an electronic document and then generated by being printed through a printing program, and the electronic document and a position coordinates combination may be stored in a printed matter information providing server.

### Advantageous Effects

According to the present invention, it is possible to extract position coordinates through a first point cluster pattern inserted into a printed matter in advance, recognize a handwritten content according to the position coordinates, and then print a second point cluster pattern according to the handwritten content to be used for authentication of the printed matter.

In addition, according to the present invention, it is possible to extract position coordinates through a first point cluster pattern inserted into a printed matter in advance, recognize a handwritten content according to the position coordinates, and then print a second point cluster pattern according to the handwritten content to be used for authentication of the printed matter.

In addition, according to the present invention, it is possible to discharge ink corresponding to a point cluster pattern together with ink corresponding to a handwritten content when the handwritten content is written on a printed matter so that the point cluster pattern can be inserted into the periphery of the handwritten content of the printed matter.

In addition, according to the present invention, it is possible to extract position coordinates through a first point cluster pattern inserted into a printed matter in advance and discharge ink through an inkjet nozzle as the position coordinates change to enable printing.

In addition, according to the present invention, it is possible to receive an electronic document corresponding to a code value from a printed matter information providing server according to a mode selected by a user, then convert a content of the electronic document into audio data, and output audio for the content or provide an artificial intelligence (AI) service for the collected audio data.

In addition, according to the present invention, it is possible to extract a code value using a point cluster pattern inserted into a printed matter, then receive an electronic document corresponding to the code value, and provide audio for the electronic document.

In addition, according to the present invention, it is possible to perform voice recognition so that a summary of sound collection content can be generated and provided.

In addition, according to the present invention, it is possible to perform voice recognition so that a translation of sound collection content can be provided in real time.

### DESCRIPTION OF DRAWINGS

FIG. 1 is a view for describing a smart pen according to one embodiment of the present invention.

FIG. 2 is a block diagram for describing an internal structure of the smart pen according to one embodiment of the present invention.

FIG. 3 is a view for describing an authentication information inserting system using the smart pen according to one embodiment of the present invention.

FIG. 4 is an exemplary view for describing a point cluster pattern automatic insertion system using the smart pen according to one embodiment of the present invention.

FIGS. 5 to 7 are views for describing a point cluster pattern formed on paper according to one embodiment of the present invention.

### MODES OF THE INVENTION

The above-described objects, features, and advantages will be described below in detail with reference to the accompanying drawings, and thus those skilled in the art to which the present invention pertains will be able to easily carry out the technical spirit of the present invention. In describing the present invention, when it is determined that a detailed description of the known technology related to the present invention may unnecessarily obscure the gist of the present invention, a detailed description thereof will be omitted. Hereinafter, exemplary embodiments according to the present invention will be described in detail with reference to the accompanying drawings. In the drawings, the same reference numerals are used to denote the same or similar components.

Among terms used in the present specification, a printed matter may include all printed matters that a user may take notes using a smart pen, such as a business card, diary, gallery, or contract.

Among the terms used in the present specification, a handwritten content may be changed depending on the type of the printed matter and may include signatures, etc.

Among the terms used in the present specification, a first point cluster pattern is a pattern that is inserted into the background screen of the printed matter in advance to enable recognition of position coordinates of each point that constitutes a point cluster. The first point cluster pattern includes a reference pattern composed of a plurality of reference dots that indicate position coordinates and a reference pattern in which vertical dotted lines with different lengths that indicate directions are formed to be spaced a specific distance from each other in a horizontal direction and a boundary dot is formed between the vertical dotted lines with different lengths.

Among the terms used in the present specification, a second point cluster pattern is a pattern that indicates printed authentication information according to the position coordinates when a user writes a handwritten content.

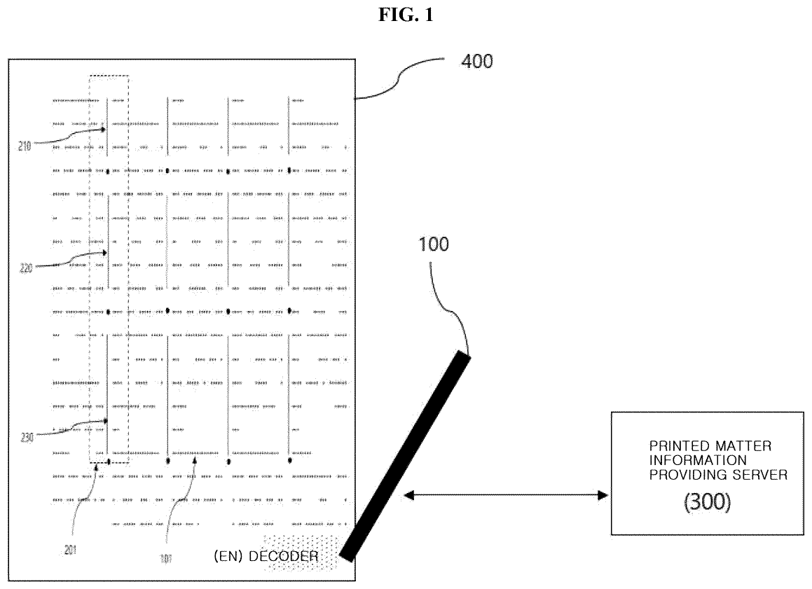

FIG. 1 is a view for describing a smart pen according to one embodiment of the present invention.

Referring to FIG. 1, a smart pen 100 is a pen that extracts position coordinates through a first point cluster pattern inserted into the printed matter in advance when a handwritten content is written on a printed matter 400 and recognizes authentication information according to the position coordinates and at the same time, prints a second point cluster pattern for authentication.

That is, when the handwritten content is written on the printed matter 400 in a state in which the first point cluster pattern is inserted into the background screen of the printed matter 400 in advance, the smart pen 100 extracts position coordinates through the first point cluster pattern and discharges ink according to the position coordinates to insert the second point cluster pattern into the periphery of the handwritten content.

As described above, since the first point cluster pattern that may be recognized through the smart pen 100 is in the state of being inserted in the printed matter 400, the position coordinates indicated by a reference dot of a reference pattern constituting the first point cluster pattern may be recognized when the smart pen 100 moves. Here, perception (or recognition) can be understood as an operation of knowing shade information of the first point cluster pattern.

The smart pen 100 may recognize the position coordinates of each reference dot that constitutes a reference pattern 101 inserted into the printed matter 400 when writing the handwritten content forward on the printed matter 400 in a process of writing at a specific position of the printed matter 400.

However, in the case in which the smart pen 100 writes at a specific position of the printed matter 400 and writing the handwritten matter in a reverse, lateral direction, etc. rather than a forward direction on the printed matter 400, when the printed matter 400 is photographed in the reverse, lateral direction, etc. rather than the forward direction, there is a problem that a photographing direction cannot be recognized, thereby not recognizing the position coordinates of each reference dot that constitutes the first point cluster pattern.

To solve the above problem, the present invention forms a reference pattern 201 indicating a direction in a state in which the reference pattern 101 of the printed matter 400 is formed so that, even when the reference pattern 101 is photographed in any direction, the photographing direction may be recognized through the reference pattern 201 to extract and provide the position coordinates indicated by the reference dot that constitutes the first point cluster pattern.

The smart pen 100 scans the printed matter 400 to generate a photographed image and then analyzes the photographed image to detect a boundary dot positioned in the middle. Thereafter, the smart pen 100 may extract the reference pattern 201 and detect other boundary dots with respect to the boundary dot positioned in the middle of the reference pattern 201.

In one embodiment, the smart pen 100 may calculate distances between other boundary dots and the boundary dot positioned in the middle of the reference pattern 201 and detect another boundary dot at a shortest distance as a region setting dot.

Thereafter, the smart pen 100 may detect a vertical dotted line extending upward or downward from the boundary dot at the shortest distance and detect a boundary dot close to an end of the vertical dotted line extending upward or downward as a region setting dot.

As described above, the smart pen 100 may determine the top or bottom of a specific region using patterns of lengths of at least three vertical dotted lines that constitute the region setting dot.

That is, the smart pen 100 may determine that the first point cluster pattern has been scanned forward in the case of a pattern in which a length of a vertical dotted line gradually becomes longer and determine that the first point cluster pattern has been scanned in a reverse direction in the case of a pattern in which a length of a vertical dotted line gradually becomes shorter.

For example, when patterns of the lengths of the vertical dotted lines are A, B, and C, it may be determined that the first point cluster pattern has been scanned forward, and when patterns of the lengths of the vertical dotted lines are C, B, and A, it may be determined that the first point cluster pattern has been scanned in the reverse direction.

In this case, when it is determined that a specific region is in the reverse direction using the patterns of the lengths of at least three vertical dotted lines that constitute the region setting dot, the specific region may be corrected by being rotated to be a forward direction.

The smart pen 100 may determine the top and bottom of the specific region to correct the specific region and then extract the position coordinates indicated by the reference dot that constitutes the first point cluster pattern of the specific region. As described above, the smart pen 100 may extract the position coordinates and then insert the second point cluster pattern for authentication according to the position coordinates.

In addition, one side of the smart pen 100 may execute a function such as an inkjet printer when an inkjet nozzle is coupled thereto.

More specifically, when the smart pen 100 is manipulated after a printing mode is set by a user, the smart pen 100 may extract the position coordinates through the point cluster pattern inserted into the printed matter in advance and discharging ink through the inkjet nozzle as the position coordinates change to perform printing. The printing mode may include a user-defined color printing mode, a texture printing mode, a handwriting mode, etc.

The smart pen 100 may receive a printing mode input through a user interface, check whether there is the user's motion through a change in position coordinates in a state in which the printing mode has been set, and then discharges ink through the inkjet nozzle to perform printing.

In this case, the smart pen 100 may scan the background of the printed matter 400, recognize a reference pixel value for the background of the printed matter as red/green/blue (RGB) using light information, convert RGB corresponding to a value increased by a specific pixel value from RGB corresponding to the reference pixel value of the background or RGB corresponding to a value decreased by a specific pixel value from RGB corresponding to the reference pixel value of the background into a CMYK (cyan, magenta, yellow, key) value based on Equations 1 and 2, combine ink according to the CMYK value, and then discharge the combined ink.

For example, the smart pen 100 may scan the background of the printed matter 400, and then use light information to convert RGB (255, 255, 255) corresponding to a value increased by a specific pixel value to a CMYK (cyan, magenta, yellow, black) value when the RGB corresponding to the reference pixel value for the background of the printed matter is (255, 255, 255), combine ink according to the CMYK value, and then discharge the combined ink.

$${R}^{′} = R / 255 \qquad [ Equation 1 ]$$

$${G}^{′} = G / 255$$

$${B}^{′} = B / 255$$

R: value corresponding to red
G: value corresponding to green
B: value corresponding to blue
R′: value by which a value corresponding to red is changed in the range of 0 to 1
G′: value by which a value corresponding to green is changed in the range of 0 to 1
B′: value by which a value corresponding to blue is changed in the range of 0 to 1

In Equation 1, since each of R, G, and B values ranges from 0 to 255, the value may be divided by 256 and changed in the range of 0 to 1 to be calculated as R′, G′, and B′.

$$K = 1 - max ( {R}^{′} , {G}^{′} , {B}^{′} ) \qquad [ Equation 2 ]$$

$$C = ( 1 - {R}^{′} - {K}^{′} ) / ( 1 - K )$$

$$M = ( 1 - {G}^{′} - K ) / ( 1 - K )$$

$$Y = ( 1 - {B}^{′} - K ) / ( 1 - K )$$

In Equation 1, since the range of R, G, and B values range from 0 to 255, the range may be divided by 256 and changed in the range of 0 to 1 to be calculated as R′, G′, and B′.

In addition, the smart pen 100 may provide audio for the document content of the printed matter 400. When the smart pen 100 writes an electronic document and then prints the electronic document through a printing program, a predetermined position coordinate combination and the electronic document are stored in the printed matter information providing server 300. Therefore, the smart pen 100 may photograph the printed matter 400, extract position coordinates using the photographed image and the first point cluster pattern of the printed matter 400 and then output audio after receiving an electronic document corresponding to the position coordinates combination from the printed matter information providing server 300.

Therefore, the smart pen 100 may provide the position coordinates to the printed matter information providing server 300 and then output audio when receiving an electronic document corresponding to the position coordinate combination from the printed matter information providing server 300.

In addition, the smart pen 100 may collect audio data and then translate and provide the collected audio data in real time.

To this end, the smart pen 100 may collect audio data, convert the audio data into text data, translate the text data with a target language, and then provide the translated text data.

In addition, the smart pen 100 may collect audio data and then generate and provide summary data of collected content.

To this end, the smart pen 100 collects audio data, converts the audio data into text data, tokenizes the text data, divides the tokenized text data into individual words or phrases, and then identifies keywords based on the frequency of each word.

First, the smart pen 100 calculates the number of times each word appears TF.

Then, the smart pen 100 calculates an inverse document frequency IDF by taking the inverse of the number of sentences or paragraphs in which each word appears. In this case, the inverse document frequency IDF is a value that takes the inverse of the frequency, and the inverse document frequency IDF of a word that appears frequently is low, and the inverse document frequency IDF of a word that appears rarely is high. That is, the smart pen 100 may calculate the inverse document frequency IDF using Equation 3 below:

$$IDF ( w ) = log ( \frac{N}{1 + DF ( w )} ) . \qquad [ Equation 3 ]$$

N: the number of total sentences or paragraphs
DF(w): the number of sentences or paragraphs in which a specific word w appears

The reason for adding 1 to the denominator in Equation 3 is to prevent the result of the natural logarithm function from being infinite by making the denominator become 0 when a certain word does not appear in the entire document.

Therefore, an inverse document frequency IDF value indicates how rare a specific word appears in a set of the entire document, and the higher this value, the higher the importance of the corresponding word.

The smart pen 100 calculates an importance score of a word using the word frequency TF and inverse document frequency IDF (W) as in Equation 4.

$$TD - IDF ( w ) = TF ( w ) * IDF ( w ) . \qquad [ Equation 4 ]$$

TF-IDF(w): importance score of word
TF(w): frequency of specific word w
IDF(w): rarity of specific word w

TF-IDF indicates the importance of a word in consideration of the frequency of appearance of the word in the document and how rare the word is in a set of the document. TF-IDF reflects that the higher the TF, the more important the corresponding word is in the document and indicates that as the IDF is higher, the corresponding word is an important word that appears uniquely in the entire document.

Thereafter, the smart pen 100 may identify an important content, which may be used for summarization among the text data using keywords, and provide summary data.

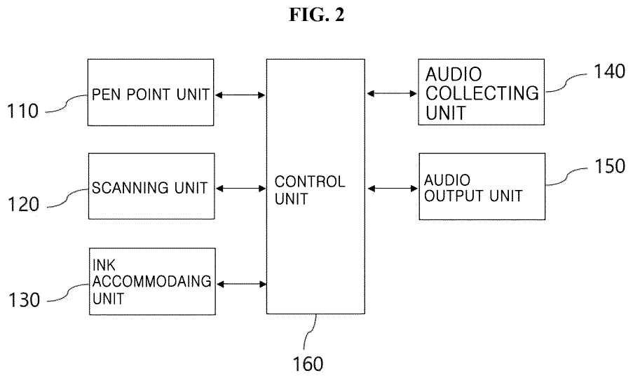

FIG. 2 is a block diagram for describing an internal structure of the smart pen according to one embodiment of the present invention.

Referring to FIG. 2, the smart pen 100 includes a pen point unit 110, a scanning unit 120, an ink accommodating unit 130, an audio collecting unit 140, an audio output unit 150, and a control unit 160.

The pen point unit 110 generates a handwritten content according to a user's manipulation through ink discharged from the ink accommodating unit 130. In this way, an ink module may be drawn from a pen point portion of the pen point unit 110 to perform a function of a general pen.

The scanning unit 120 may extract position coordinates by scanning the printed matter 400 and the first point cluster pattern inserted into the printed matter 400 in advance.

In one embodiment, the scanning unit 120 may extract position coordinates through the first point cluster pattern when writing a handwritten content on the printed matter 400 in a state in which the first point cluster pattern is inserted into the background screen of the printed matter 400 in advance and provide the extracted position coordinates to the control unit 160.

As described above, since the first point cluster pattern that may be recognized through the smart pen 100 is in the state of being inserted in the printed matter 400, the position coordinates indicated by a reference dot of a reference pattern constituting the first point cluster pattern may be recognized when the smart pen 100 moves. Here, perception (or recognition) can be understood as an operation of knowing shade information of the first point cluster pattern.

The scanning unit 120 may recognize position coordinates of each reference dot that constitutes the reference pattern 101 inserted into the printed matter 400 when writing the handwritten matter forward on the printed matter 400 in a process of writing the handwritten content at a specific position of the printed matter 400.

However, in the case in which the smart pen 100 writes at a specific position of the printed matter 400 and writing the handwritten matter in a reverse, lateral direction, etc. rather than a forward direction on the printed matter 400, when the printed matter 400 is photographed in the reverse, lateral direction, etc. rather than the forward direction, there is a problem that a photographing direction cannot be recognized, and thus the position coordinates of each reference dot that constitutes the first point cluster pattern cannot be recognized.

To solve the above problem, the present invention forms a reference pattern 201 indicating a direction in a state in which the reference pattern 101 of the printed matter 400 is formed so that, even when the reference pattern 101 is photographed in any direction, the photographing direction may be recognized through the reference pattern 201 to extract and provide the position coordinates indicated by the reference dot that constitutes the first point cluster pattern.

The scanning unit 120 scans the printed matter 400 to generate a photographed image and then analyzes the photographed image to detect a boundary dot positioned in the middle. Thereafter, the smart pen 100 may extract the reference pattern 201 and detect other boundary dots with respect to the boundary dot positioned in the middle of the reference pattern 201.

In one embodiment, the scanning unit 120 may calculate distances between other boundary dots and the boundary dot positioned in the middle of the reference pattern 201 and detect another boundary dot at a shortest distance as a region setting dot.

Thereafter, the scanning unit 120 may detect a vertical dotted line extending upward or downward from the boundary dot at the shortest distance and detect a boundary dot close to an end of the vertical dotted line extending upward or downward as a region setting dot.

As described above, the scanning unit 120 may determine the top or bottom of a specific region using patterns of lengths of at least three vertical dotted lines that constitute the region setting dot.

That is, the scanning unit 120 may determine that the first point cluster pattern has been scanned forward when the pattern of the length of the vertical dotted line gradually becomes longer and determine that the first point cluster pattern has been scanned in a reverse direction when the pattern of the length of the vertical dotted line gradually becomes shorter.

For example, when patterns of the lengths of the vertical dotted lines are A, B, and C, it may be determined that the first point cluster pattern has been scanned forward, and when patterns of the lengths of the vertical dotted lines are C, B, and A, it may be determined that the first point cluster pattern has been scanned in the reverse direction.

In this case, when it is determined that a specific region is in the reverse direction using the patterns of the lengths of at least three vertical dotted lines that constitute the region setting dot, the specific region may be corrected by being rotated to be a forward direction. The scanning unit 120 may determine the top and bottom of the specific region to correct the specific region, and then extract position coordinates indicated by the reference dot that constitutes the first point cluster pattern of the specific region and provide the extracted position coordinates to the control unit 160.

The ink accommodating units 130 accommodate inks having different colors.

In one embodiment, color inks and transparent inks corresponding to CMY (cyan, magenta, yellow) are stored in each ink accommodating unit 130. In this case, the color ink and the transparent ink may be used to insert the handwritten content according to the user's manipulation and the second point cluster pattern near the handwritten content, used to generate the handwritten content, and used to express the printing mode set by the user.

In another embodiment, color inks and transparent inks corresponding to CMYK are stored in each ink accommodating unit 130. In this case, the color ink and the transparent ink may be used to insert the handwritten content according to the user's manipulation and the second point cluster pattern near the handwritten content, used to generate the handwritten content, and used to express the printing mode set by the user.

Different colored inks stored in each ink accommodating unit 130 are mixed after being discharged according to the control of the control unit 160 and provided externally through the pen point unit 110 so as to be printed on the printed matter 400 according to the handwritten content, the second point cluster pattern, and the printing mode set by the user.

The control unit 160 may control specific ink among the inks in the ink accommodating unit 130 to be discharged.

In one embodiment, the control unit 160 may control specific ink among the inks in the ink accommodating unit 130 to be discharged so as to insert a second point cluster pattern for authentication according to the position coordinates received from the scanning unit 120.

In another embodiment, the control unit 160 may receive position coordinates from the scanning unit 120 in a manipulating process of the user after the printing mode is set by the user and control specific ink among the inks in the ink accommodating unit 130 to be discharged as the position coordinates change.

In still another embodiment, the control unit 160 may receive position coordinates from the scanning unit 120 in a manipulating process of the user after a color is selected by the user and control specific ink among the inks in the ink accommodating unit 130 to be discharged as the position coordinates change.

The control unit 160 may provide the position coordinates to the printed matter information providing server 300 and then, when receiving an electronic document corresponding to a position coordinate combination from the printed matter information providing server 300, output audio for the electronic document through the audio output unit 150.

In addition, the control unit 160 may collect audio data and then translate and provide the audio data in real time.

To this end, the control unit 160 may collect the audio data through the audio collecting unit 140, convert the audio data into text data, translate the text data with a target language, and provide the translated text data through the audio output unit 150.

In addition, when the mode selected by the user is an audio data summary mode, the control unit 160 may collect audio data through the audio collecting unit 140 and then generate and provide summary data of the collected content.

To this end, the control unit 160 collects audio data, converts the audio data into text data, tokenizes the text data, divides the tokenized text data into individual words or phrases, and then identifies keywords based on the frequency of each word.

First, the control unit 160 calculates the number of times each word appears TF.

Then, the control unit 160 calculates an inverse document frequency IDF by taking the inverse of the number of sentences or paragraphs in which each word appears. In this case, the inverse document frequency IDF is a value that takes the inverse of the frequency, and the inverse document frequency IDF of a word that appears frequently is low, and the inverse document frequency IDF of a word that appears rarely is high. That is, the smart pen 100 may calculate the inverse document frequency IDF using Equation 1 below.

Thereafter, the control unit 160 of the smart pen 100 capable of voice recognition may calculate the importance score of a word using the word frequency TF and the inverse document frequency IDF(w) as in Equation 2.

TF-IDF indicates the importance of a word in consideration of the frequency of appearance of the word in the document and how rare the word is in a set of the document. TF-IDF reflects that the higher the TF, the more important the corresponding word is in the document and indicates that as the IDF is higher, the corresponding word is an important word that appears uniquely in the entire document.

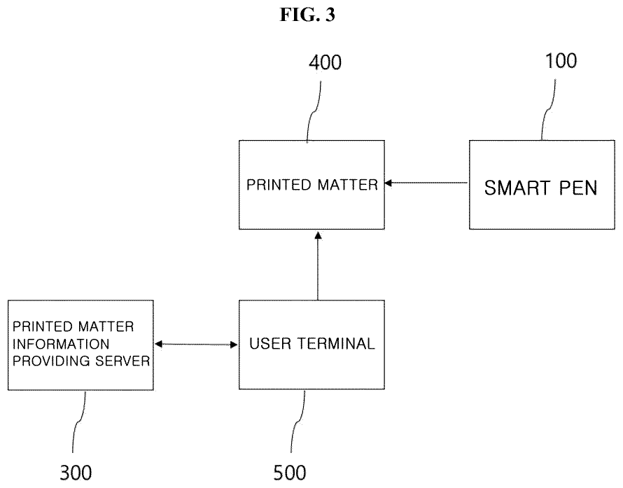

FIG. 3 is a view for describing an authentication information inserting system using the smart pen according to one embodiment of the present invention.

Referring to FIG. 3, the point cluster pattern automatic insertion system using a smart pen includes the smart pen 100, the printed matter information providing server 300, and a user terminal 500.

When writing a handwritten content on the printed matter 400, the smart pen 100 may discharge ink corresponding to the second point cluster pattern together with ink corresponding to the handwritten content to a peripheral region to insert the second point cluster pattern into the periphery of the handwritten content of the printed matter 400.

When writing the handwritten content on the printed matter, the smart pen 100 may extract position coordinates through the first point cluster pattern inserted into the printed matter in advance, recognize authentication information according to the position coordinates, and at the same time, print the second point cluster pattern for authentication.

A body of the smart pen 100 is a typical ballpoint pen body, is a pipe-shaped body with a cylindrical or polygonal cross-section, and has the same size as a ballpoint pen. A plurality of ink modules are present inside the smart pen 100, and the ink module may include color ink corresponding to CMYK and transparent ink.

The ink module may be drawn from the pen point portion of the smart pen 100 to perform a function of a general pen.

In one embodiment, the smart pen 100 may discharge transparent ink to generate the second point cluster pattern generated in advance near the handwritten content together with the handwritten content when the user writes the handwritten content on the printed matter 400.

In this case, since the second point cluster pattern may be generated in a form that is invisible by a transparent printing layer having a code value, there is no physical color difference to provide a form that cannot be replicated by an optical device such as a copier. In addition, the transparent printing layer may be formed by mixing general ink and resin.

Of course, the second point cluster pattern preferably has a code value corresponding to identification information. Since this is to extract a code value corresponding to identification information from the printed matter 400 using spread reflection of light, the transparent printing layer may have various shapes, but preferably has a convex embossed shape.

In addition, when the transparent printing layer has an invisible shape, the second point cluster pattern may be formed in any shape. For example, the transparent printing layer may have a quadrangular shape and may be formed in an engraved shape. In this case, the engraved shape may indicate 0 or 1. That is, it can be defined in advance that an embossed shape indicates 0 and the engraved shape indicates 1, and it can be defined in advance that the embossed shape indicates 1 and the engraved shape indicates 0.

That is, since the transparent printing layer is in a state in which the code value corresponding to identification information that may be recognized through the user terminal 500 is printed, for example, with transparent ink, the transparent printing layer connects the information of the printed matter corresponding to the identification information. The identification information may be various pieces of information using the characteristics of light.

For example, various pieces of information using the characteristics of light may be a reflection speed of light, a pixel value of a photographed image, that is, an image including spread reflection, and a luminance value among the pixel values.

In this way, the embodiment of the present invention may be used to extract a gradation value when there is no spread reflection and a gradation value when there is spread reflection as a code value corresponding to the identification information according to the embodiment of the present invention. In addition, since various factors due to spread reflection may be used to provide information, the embodiment of the present invention will not be specifically limited to any one.

In another embodiment, the smart pen 100 may discharge color ink to generate the second point cluster pattern generated in advance near the handwritten content together with the handwritten content when the user writes the handwritten content on the printed matter 400.

To this end, the smart pen 100 may recognize the reference pixel value of the background of the printed matter 400 when the user writes the handwritten content on the printed matter 400 and combine and discharge ink to become a color corresponding to a value increased by a specific pixel value based on the reference pixel value of the background or a value decreased by the specific pixel value based on the reference pixel value.

More specifically, the smart pen 100 may scan the background of the printed matter 400, recognize the reference pixel value for the background of the printed matter as RGB using light information, convert RGB corresponding to the value increased by the specific pixel value from RGB corresponding to the reference pixel value of the background or RGB corresponding to the value decreased by a specific pixel value from RGB corresponding to the reference pixel value of the background into a CMYK value, combine ink according to the CMYK value, and then discharge the combined ink.

As described above, the smart pen 100 may discharge color ink to generate the second point cluster pattern generated near the handwritten content in advance together with the handwritten content when the user writes the handwritten content on the printed matter 400 to insert the second point cluster pattern into the periphery of the handwritten content.

The user terminal 500 is a terminal that recognizes the handwritten content of the printed matter 400 to extract an identification code and authenticates the printed matter 400 according to the identification code.

The user terminal 500 may execute an application (hereinafter referred to as “app”) for scanning the printed matter 400. Therefore, when the user executes the app to scan the printed matter 400 and then points a camera on a surface of the printed matter 400, a flash automatically operates and a photo is taken. Rather than photographing a video, it is preferable to secure a photographed image of a still image by taking a single photo.

That is, since the printed matter 400 is in a state in which a code value that may be recognized through the app is printed, for example, with transparent ink, the code value obtained by being reflected through the flash embedded in the user terminal 500 is recognized and then connected to the identification information. Here, the code value may be various pieces of information using the characteristics of light.

For example, various pieces of information may include a reflection speed of light, a pixel value of the photographed image, that is, an image including spread reflection, and a luminance value among pixel values. In this way, the user terminal 500 extracts the code value from the spread reflection of the second point cluster pattern, transmits the extracted code value to the printed matter information providing server 300, and extracts and provides the code value inserted into the printed matter 400.

Since the code value may be extracted through the app of the user terminal 500, but extracted in the printed matter information providing server 300, the embodiment of the present invention will not be particularly limited to any one form.

The photographed image photographed by the user terminal 500 may be provided to the printed matter information providing server 300 and provided by extracting the code value from the printed matter 400 using the photographed image photographed directly through the app. Alternatively, the app may extract only the code value from the photographed image and transmit the extracted code value to the printed matter information providing server 300. In this case, the code value may be in the form of binary bits, and the code value when there is spread reflection clearly differs from the code value when there is no spread reflection.

Thereafter, the user terminal 500 provides the code value to the printed matter information providing server 300 and when receiving and displaying printed matter owner request data connected to the identification information among the code values from the printed matter information providing server 300, correspondingly stores the identification information and the photographed image.

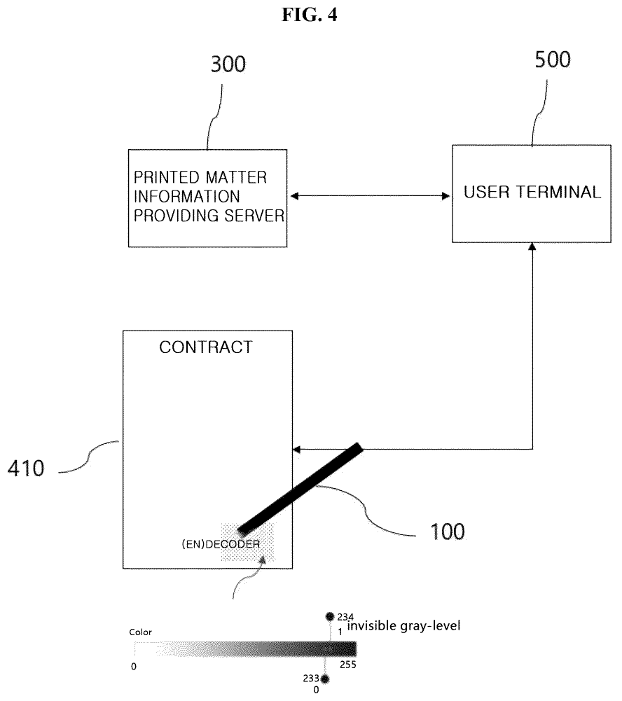

FIG. 4 is an exemplary view for describing a point cluster pattern automatic insertion system using the smart pen according to one embodiment of the present invention. One embodiment of FIG. 4 relates to one embodiment in which a point cluster pattern may be automatically inserted when a signature is written using a smart pen when the type of a printed matter is a contract.

Referring to FIG. 4, the second point cluster pattern automatic insertion system using a smart pen includes the smart pen 100, the printed matter information providing server 300, and the user terminal 500.

The smart pen 100 has an advantage that the second point cluster pattern may be inserted into the periphery of the signature of a contract 410 by discharging ink corresponding to the signature near the signature together with ink corresponding to the second point cluster pattern when the signature is written on the contract 410.

The body of the smart pen 100 is a typical ballpoint pen body, is a pipe-shaped body with a cylindrical or polygonal cross-section, and has the same size as a ballpoint pen. The plurality of ink modules are present inside the smart pen 100, and the ink module may include color ink corresponding to CMYK and transparent ink.

The ink module may be drawn from the pen point portion of the smart pen 100 to perform a function of a general pen.

In one embodiment, the smart pen 100 may discharge transparent ink to generate the second point cluster pattern generated in advance near the signature together with the signature when the user writes the signature on the contract 410.

In this case, since the second point cluster pattern may be generated in a form that is invisible by a transparent printing layer having a code value, there is no physical color difference to provide a form that cannot be replicated by an optical device such as a copier. In addition, the transparent printing layer may be formed by mixing general ink and resin.

Of course, the second point cluster pattern preferably has a code value corresponding to identification information. Since this is to extract a code value corresponding to identification information from the contract 410 using spread reflection of light, the transparent printing layer may have various shapes, but preferably has a convex embossed shape.

In addition, when the transparent printing layer has an invisible shape, the second point cluster pattern may be formed in any shape. For example, the transparent printing layer may have a quadrangular shape and may be formed in an engraved shape. In this case, the engraved shape may indicate 0 or 1. That is, it can be defined in advance that an embossed shape indicates 0 and the engraved shape indicates 1, and it can be defined in advance that the embossed shape indicates 1 and the engraved shape indicates 0.

That is, since the transparent printing layer is in a state in which the code value corresponding to identification information that may be recognized through the user terminal 500 is printed, for example, with transparent ink, the transparent printing layer connects the information of the contract 410 corresponding to the identification information. The identification information may be various pieces of information using the characteristics of light.

For example, various pieces of information using the characteristics of light may include a reflection speed of light, a pixel value of a photographed image, that is, an image including spread reflection, and a luminance value among the pixel values.

In this way, the embodiment of the present invention may be used to extract a gradation value when there is no spread reflection and a gradation value when there is spread reflection as a code value corresponding to the identification information according to the embodiment of the present invention. In addition, since various factors due to spread reflection may be used to provide information, the embodiment of the present invention will not be specifically limited to any one.

In another embodiment, the smart pen 100 may discharge color ink to generate the second point cluster pattern generated in advance near the signature together with the signature when the user writes the signature on the contract 410.

To this end, the smart pen 100 may recognize the reference pixel value of the background of the contract 410 when the user writes the signature on the contract 410 and combine and discharge ink to become a color corresponding to a value increased by a specific pixel value based on the reference pixel value of the background or a value decreased by the specific pixel value based on the reference pixel value.

More specifically, the smart pen 100 may scan the background of the contract 410, recognize the reference pixel value for the background of the contract 410 as RGB using light information, convert RGB corresponding to the value increased by the specific pixel value from RGB corresponding to the reference pixel value of the background or RGB corresponding to the value decreased by a specific pixel value from RGB corresponding to the reference pixel value of the background into a CMYK value, combine ink according to the CMYK value, and then discharge the combined ink.

For example, the smart pen 100 may scan the background of the contract 410, and then use light information to convert RGB (255, 255, 255) corresponding to a value increased by a specific pixel value to a CMYK value when the RGB corresponding to the reference pixel value for the background of the contract 410 is (255, 255, 255), combine ink according to the CMYK value, and then discharge the combined ink.

As described above, the smart pen 100 may discharge color ink to generate the second point cluster pattern generated near the signature in advance together with the signature when the user writes the signature on the contract 410 to insert the second point cluster pattern into the periphery of the signature.

The user terminal 500 is a terminal that recognizes the signature of the contract 410 to extract an identification code and authenticates the contract 410 according to the identification code.

The user terminal 500 may execute an application (hereinafter referred to as “app”) for scanning the contract 410. Therefore, when the user executes the app to scan the contract 410 and then points a camera on a surface of the contract 410, a flash automatically operates and a photo is taken. Rather than photographing a video, it is preferable to secure a photographed image of a still image by taking a single photo.

That is, since the contract 410 is in a state in which a code value that may be recognized through the app is printed, for example, with transparent ink, the code value obtained by being reflected through the flash embedded in the user terminal 500 is recognized and then connected to the identification information. Here, the code value may be various pieces of information using the characteristics of light.

For example, various pieces of information may include a reflection speed of light, a pixel value of the photographed image, that is, an image including spread reflection, and a luminance value among pixel values. In this way, the user terminal 500 extracts the code value from the spread reflection of the second point cluster pattern, transmits the extracted code value to the printed matter information providing server 300, and extracts and provides the code value inserted into the contract 410.

Since the code value may be extracted through the app of the user terminal 500, but extracted in the printed matter information providing server 300, the embodiment of the present invention will not be particularly limited to any one form.

The photographed image photographed by the user terminal 500 may be provided to the printed matter information providing server 300 and provided by extracting the code value from the contract 410 using the photographed image photographed directly through the app.

Alternatively, the app may extract only the code value from the photographed image and transmit the extracted code value to the printed matter information providing server 300. In this case, the code value may be in the form of binary bits, and the code value when there is spread reflection clearly differs from the code value when there is no spread reflection.

Thereafter, the user terminal 500 provides the code value to the printed matter information providing server 300 and when receiving and displaying printed matter owner request data connected to the identification information among the code values from the printed matter information providing server 300, correspondingly stores the identification information and the photographed image.

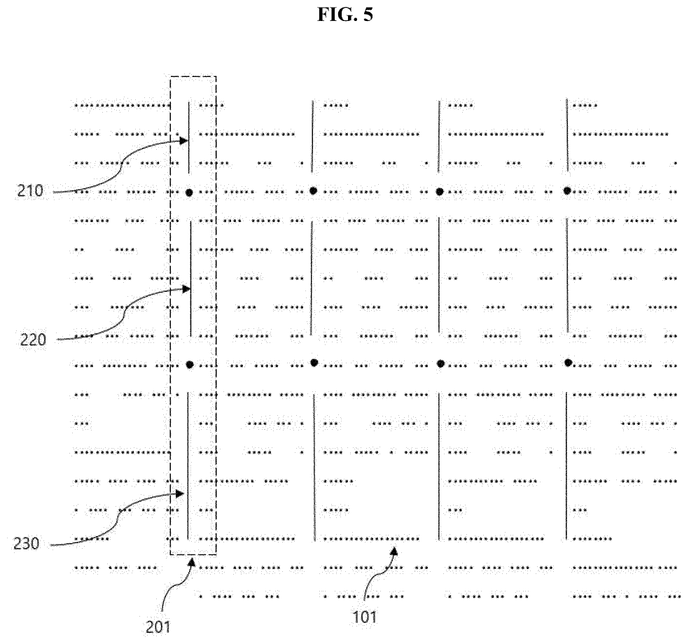

FIGS. 5 to 7 are views for describing a point cluster pattern formed on paper according to one embodiment of the present invention.

Referring to FIGS. 5 to 7, a first point cluster pattern formed on paper may include a reference pattern 101 composed of a plurality of reference dots indicating position coordinates, and a reference pattern 201 in which vertical dotted lines with different lengths indicating directions are formed to be spaced a specific distance from each other in a horizontal direction and a boundary dot is formed between the vertical dotted lines with different lengths.

Each of the plurality of reference dots that constitute the reference pattern 101 may indicate specific position coordinates on predetermined global coordinates. For example, when the global coordinates are from (0, 0) to (100, 100), the plurality of reference dots may be determined to be position coordinates of one between (0, 0) and (100, 100) depending on a position.

When the smart pen decodes the reference pattern 101, the position coordinates of each reference dot that constitutes the reference pattern 101 may be recognized when the reference pattern 101 is photographed forward in a process of scanning the reference pattern 101.

However, when the smart pen decodes the first point cluster pattern, when the reference pattern 101 is photographed in a reverse direction, lateral direction, etc. rather than a forward direction, there is a problem that a photographing direction cannot be recognized, thereby not recognizing the position coordinates of each reference dot that constitutes the first point cluster pattern.

To solve the above problem, the present invention forms the reference pattern 201 indicating a direction in a state in which the reference pattern 101 is formed so that, even when the reference pattern 101 is photographed in any direction, the photographing direction may be recognized through the reference pattern 201 to extract and provide the position coordinates indicated by the reference dot that constitutes the first point cluster pattern.

To this end, the reference pattern 201 is formed so that the vertical dotted lines with different lengths indicating directions are formed to be spaced a specific distance from each other in the horizontal direction, and a boundary dot is formed between the vertical dotted lines with different lengths.

In one embodiment, the vertical dotted lines of the reference pattern 201 may be formed so that a first vertical dotted line 210 with a first length, a second vertical dotted line 220 with a second length larger by a specific length than the first length, and a third vertical dotted line 230 with a third length larger by a specific length than the second length are spaced a specific distance from each other in the horizontal direction.

In addition, each of the first vertical dotted line 210, the second vertical dotted line 220, and the third vertical dotted line 230 may be formed to be spaced the specific distance from each other, and boundary dots may be formed between the first vertical dotted line 210, the second vertical dotted line 220, and the third vertical dotted line.

For example, when the patterns of the lengths of the vertical dotted lines are A, B, and C, it may be determined that the first point cluster pattern has been scanned forward, and when the patterns of the lengths of the vertical dotted lines are C, B, and A, it may be determined that the first point cluster pattern has been scanned in the reverse direction.

As described above, the reason for differently implementing the lengths of the first vertical dotted line 210, the second vertical dotted line 220, and the third vertical dotted line 230 is that a short vertical dotted line may indicate any one of upward and downward directions from the entire coordinate and a long vertical dotted line may indicate the other of the upward and downward directions.

Therefore, when the smart pen scans the reference pattern 101 to generate an image of the first point cluster pattern, the smart pen detects a boundary dot positioned in the middle of the image of the point cluster pattern, detects other boundary dots with respect to the boundary dot positioned in the middle, and then connects the other boundary dots to detect a specific region.

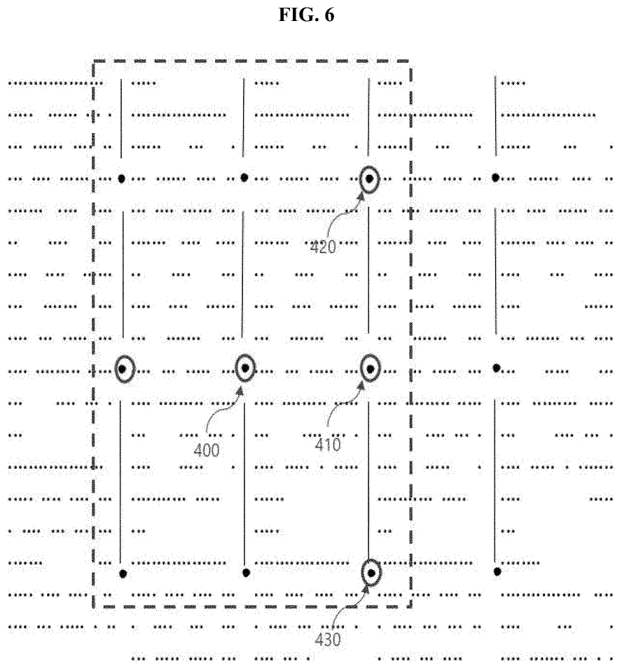

That is, as shown in FIG. 6, the smart pen scans the first point cluster pattern and then detects a boundary dot 401 positioned in the middle of the reference pattern 201.

The smart pen detects other boundary dots 401, 420, and 430 with respect to the boundary dot 401 positioned in the middle.

In one embodiment, the smart pen may calculate distances between the other boundary dots 401, 420, and 430 and the boundary dot 401 positioned in the middle and detect another boundary dot 410 at a shortest distance as a region setting dot.

Thereafter, the smart pen may detect a vertical dotted line extending upward or downward from the boundary dot 410 at the shortest distance and detect the boundary dots 420 and 430 close to an end of the vertical dotted line extending upward or downward as region setting dots.

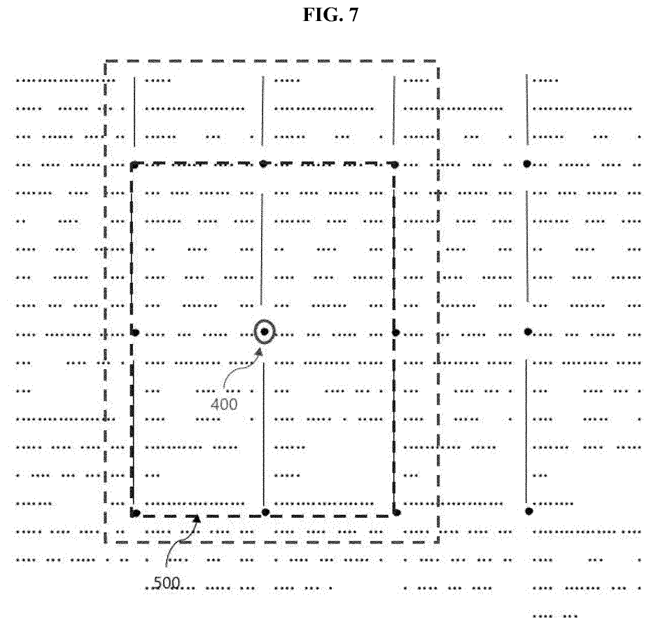

As shown in FIG. 7, the smart pen connects the other boundary dots to generate a specific region 600 and determines the top and bottom of the specific region 600.

That is, the smart pen may detect the vertical dotted line extending upward or downward from the boundary dot close to the center, compare a length between the vertical dotted lines extending upward and downward, and when the vertical dotted line extending upward is longer than the vertical dotted line extending downward, determine that a downward direction is an upward direction of the point cluster pattern.

The smart pen determines the top and bottom of the specific region 500 to correct the specific region 500 and then decodes the second point cluster pattern of the specific region 500.

Although the present invention has been described by limited embodiments and drawings, the present invention is not limited to the above embodiments, and various modifications and changes are possible by those skilled in the art to which the present invention pertains from such descriptions. Therefore, the spirit of the present invention should be understood only by the scope of the appended claims, and all equivalent or equivalent modifications thereof are considered to fall within the scope of the spirit of the present invention.

1. A smart pen comprising:
an ink accommodating unit in which inks having different colors are accommodated;
a scanning unit configured to extract position coordinates through a first point cluster pattern inserted into a printed matter in advance when a user writes a handwritten content on the printed matter;
a pen point unit configured to print the handwritten content according to the user's manipulation through the ink discharged from the ink accommodating unit; and
a control unit configured to receive the position coordinates from the scanning unit in a manipulating process of the user and control specific ink among the inks in the ink accommodating unit to be discharged according to the position coordinates.

2. The smart pen of claim 1, wherein the scanning unit scans the printed matter to generate a photographed image, analyzes the photographed image to extract a reference pattern on which a boundary dot is formed between a plurality of vertical dotted lines with different lengths, analyzes patterns of the plurality of vertical dotted lines that constitute the reference pattern, and corrects a recognition direction to a forward direction to extract position coordinates indicated by the first point cluster pattern.

3. The smart pen of claim 2, wherein the scanning unit scans the printed matter to generate and analyze the photographed image, detects a boundary dot positioned in a middle, calculates distances between the boundary dot positioned in the middle and other boundary dots, and detects another boundary dot at a shortest distance as a region setting dot.

4. The smart pen of claim 3, wherein the scanning unit detects a vertical dotted line extending upward or downward from the another boundary dot at the shortest distance and detects a boundary dot close to an end of the vertical dotted line extending upward or downward as a region setting dot.

5. The smart pen of claim 3, wherein the scanning unit determines a top and bottom of a specific region using patterns of lengths of at least three vertical dotted lines that constitute the region setting dot, corrects a corresponding region according to a result of the determination, and then extracts position coordinates of each first point cluster pattern of the corresponding region.

6. The smart pen of claim 1, wherein the control unit controls the specific ink among the inks in the ink accommodating unit to be discharged so that a second point cluster pattern is output according to the position coordinates.

7. The smart pen of claim 6, wherein the second point cluster pattern is used to check whether authenticity of the printed matter is verified by extracting a code value after scanning the printed matter with a user terminal when the printed matter is authenticated and then comparing the code value with a pre-stored code value.

8. The smart pen of claim 1, wherein the first point cluster pattern includes a reference pattern composed of a plurality of reference dots that indicate position coordinates, and a reference pattern in which vertical dotted lines with different lengths that indicate directions are formed to be spaced a specific distance from each other in a horizontal direction and a boundary dot is formed between the vertical dotted lines with different lengths.

9. The smart pen of claim 1, further comprising:
an audio collecting unit configured to collect external audio data; and
an audio output unit configured to output audio data.

10. The smart pen of claim 9, wherein the control unit receives an electronic document corresponding to a position coordinate combination that combines the position coordinates received from the scanning unit from a printed matter information providing server, converts a content of the electronic document into the audio data, and outputs the audio data through the audio output unit or provides an artificial intelligence (AI) service for the audio data collected through the audio collecting unit.

11. The smart pen of claim 10, wherein the control unit transmits a code value extracted by the scanning unit to the printed matter information providing server when a mode selected by the user is a document content audio output mode and when receiving an electronic document corresponding to the code value from the printed matter information providing server through a communication unit, converts text data of the electronic document into audio data and controls the audio data to be provided through the audio output unit.

12. The smart pen of claim 10, wherein, when the mode selected by the user is a translation mode, the control unit collects audio data through the audio collecting unit, converts the audio data into text data, and then translates the text data with a target language to provide the translated text data through the audio output unit.

13. The smart pen of claim 10, wherein, when the mode selected by the user is a summary mode, the control unit collects audio data through the audio collecting unit and then generates summary data of collected content to provide the summary data to a user terminal.

14. The smart pen of claim 1, wherein, after a printing mode is set and the user manipulates the smart pen, the control unit receives the position coordinates from the scanning unit in a manipulating process of the user and controls the specific ink among the inks in the ink accommodating unit to be discharged as the position coordinates change.

15. The smart pen of claim 14, wherein the printing mode includes at least one of a user setting color printing mode, a texture printing mode, and a handwriting mode.

16. The smart pen of claim 1, wherein the printed matter is written as an electronic document and then generated by being printed through a printing program, and the electronic document and a position coordinate combination are stored in a printed matter information providing server.
